(19) United States
(12) Patent Application Publication
(10) Pub. No.: US 2022/0010169 A1
(43) Pub. Date: Jan. 13, 2022

(54) CURABLE COATING COMPOSITIONS, METHODS, AND ARTICLES

(71) Applicant: 3M INNOVATIVE PROPERTIES COMPANY, St Paul, MN (US)

(72) Inventors: Jon P. Nietfeld, Woodbury, MN (US); Richard S. Buckanin, Rochester, MN (US); Ara Z. Nercissiantz, Los Angeles, CA (US); Chad M. Amb, Roberts, WI (US); Steven J. McMan, Stillwater, MN (US); Kevin R. Ansell, White Bear Lake, MN (US)

(21) Appl. No.: 17/295,305

(22) PCT Filed: Nov. 18, 2019
(86) PCT No.: PCT/IB2019/059896

§ 371 Date: May 19, 2021

Related U.S. Application Data
(60) Provisional application No. 62/771,464, filed on Nov. 26, 2018.

(51) Int. Cl. C09D 183/04; C09D 7/63; C09D 7/20; C08G 77/12; C08K 5/3495

(52) U.S. Cl. CPC C09D 183/04; C09D 7/63; C08K 5/3495; C08G 77/12; C09D 7/20

(57) ABSTRACT

A curable composition including: at least one polyorganosiloxane including at least one hydrosilyl moiety (in certain embodiments, two different polyorganosiloxanes); at least one silane including hydrolyzable functionality; and at least one base selected from an amidine, a guanidine, a phosphazene, a proazaphosphatrane, and a combination thereof; a method of coating such curable composition; and an article having a substrate surface with a coating formed from such method.

### BACKGROUND

Painted metal surfaces such as found in motor vehicles are ubiquitous. In normal use these surfaces are regularly exposed to weather effects such as rain, snow, sleet, ice formation, and other precipitation, as well as environmental contaminants (e.g., dirt, grime, dust, air-borne pollutants, road surface residue, bird and other animal waste, etc.). It is desirable to maintain the physical condition of these vehicles by cleaning or washing them and, in some cases, subsequently waxing and polishing or buffing them.

Many products that are intended to improve or restore a vehicle's finish are commercially available. Compositions that are easy to use, that can impart an excellent appearance to the vehicle, and then can sustain that appearance, even after repeated or prolonged exposure to the weather or frequent vehicle cleaning and washing cycles, are especially valued. In particular, compositions are needed that provide a balance of desirable properties on a variety of substrates (e.g., glass, plastic, metal, painted surfaces) that form a vehicle.

### SUMMARY OF THE DISCLOSURE

The present disclosure provides curable compositions, methods, and articles. The compositions provide a balance of desirable properties on a variety of substrates, such as glass, plastic, metal, a painted surface, or a combination thereof.

In certain embodiments, the present disclosure provides a curable composition including: at least one polyorganosiloxane including at least one hydrosilyl moiety (in certain embodiments, two different polyorganosiloxanes); at least one silane including hydrolyzable functionality; and at least one base selected from an amidine, a guanidine, a phosphazene, a proazaphosphatrane, and a combination thereof. In certain embodiments, such composition further includes at least one non-halogenated organic solvent having a boiling point of at least 160° C.

In certain embodiments, the present disclosure provides a method including: providing a curable composition as described herein (with or without a silane including hydrolyzable functionality); providing a substrate having a surface; applying the curable composition to at least a portion of the surface of the substrate; and allowing or inducing the curable composition to at least partially cure to form a coating. In certain embodiments, allowing or inducing the curable composition to at least partially cure occurs for a period of at least 0.1 minute (or at least 1 minute). In certain embodiments, the method includes removing uncured curable composition after at least partially curing the composition.

In certain embodiments, the present disclosure provides an article including a substrate having a surface and a coating prepared by such coating method.

As used herein:

The term “aliphatic group” means a saturated or unsaturated linear, branched, or cyclic hydrocarbon group. This term is used to encompass alkyl, alkenyl, and alkynyl groups, for example.

The term “alkyl” refers to a monovalent group that is a radical of an alkane and includes straight-chain, branched, cyclic, and bicyclic alkyl groups, and combinations thereof, including both unsubstituted and substituted alkyl groups. Unless otherwise indicated, the alkyl groups typically contain from 1 to 30 carbon atoms. In some embodiments, the alkyl groups contain 1 to 20 carbon atoms, 1 to 10 carbon atoms, 1 to 6 carbon atoms, 1 to 4 carbon atoms, or 1 to 3 carbon atoms. Examples of “alkyl” groups include, but are not limited to, methyl, ethyl, n-propyl, n-butyl, n-pentyl, isobutyl, t-butyl, isopropyl, n-octyl, n-heptyl, ethylhexyl, cyclopentyl, cyclohexyl, cycloheptyl, adamantyl, norbornyl, and the like.

The term “alkylene” refers to a divalent group that is a radical of an alkane and includes groups that are linear, branched, cyclic, bicyclic, or a combination thereof. Unless otherwise indicated, the alkylene group typically has 1 to 30 carbon atoms. In some embodiments, the alkylene group has 1 to 20 carbon atoms, 1 to 10 carbon atoms, 1 to 6 carbon atoms, or 2 to 5 carbon atoms, or 1 to 4 carbon atoms. Examples of “alkylene” groups include methylene, ethylene, propylene, 1,4-butylene, 1,4-cyclohexylene, and 1,4-cyclohexyldimethylene.

The term “allyl group” is a functional group has the formula H₂C═CH—CH₂—, which consists of a methylene bridge (—CH₂—) attached to a vinyl group (—CH═CH₂).

The term “amino group” is a functional group that consists of a nitrogen atom attached by single bonds to hydrogen atoms, alkyl groups, aryl groups, or a combination of these three. Primary amino groups include two hydrogen atoms bonded to the nitrogen, secondary amino groups include one hydrogen atom bonded to the nitrogen, and tertiary amino groups include no hydrogen atoms bonded to the nitrogen.

The term “anhydrous” in the context of a curable composition means that the composition includes little (less than 1 percent by weight (wt-%)) or no water.

The term “aryl” refers to a monovalent group that is aromatic and, optionally, carbocyclic. The aryl has at least one aromatic ring. Any additional rings can be unsaturated, partially saturated, saturated, or aromatic. Optionally, the aromatic ring can have one or more additional carbocyclic rings that are fused to the aromatic ring. Unless otherwise indicated, the aryl groups typically contain from 6 to 30 carbon atoms. In some embodiments, the aryl groups contain 6 to 20, 6 to 18, 6 to 16, 6 to 12, or 6 to 10 carbon atoms. Examples of an aryl group include phenyl, naphthyl, biphenyl, phenanthryl, and anthracyl.

The term “arylene” refers to a divalent group that is aromatic and, optionally, carbocyclic. The arylene has at least one aromatic ring. Optionally, the aromatic ring can have one or more additional carbocyclic rings that are fused to the aromatic ring. Any additional rings can be unsaturated, partially saturated, or saturated. In some embodiments, the arylene group has up to 5 rings, up to 4 rings, up to 3 rings, up to 2 rings, or one aromatic ring. For example, the arylene group can be phenylene. Unless otherwise specified, arylene groups often have 6 to 20 carbon atoms, 6 to 18 carbon atoms, 6 to 16 carbon atoms, 6 to 12 carbon atoms, or 6 to 10 carbon atoms.

The term “aralkyl” refers to a monovalent group that is an alkyl group substituted with an aryl group (e.g., as in a benzyl group). The term “alkaryl” refers to a monovalent group that is an aryl substituted with an alkyl group (e.g., as in a tolyl group). Unless otherwise indicated, for both groups, the alkyl portion often has 1 to 10 carbon atoms, 1 to 6 carbon atoms, or 1 to 4 carbon atoms and an aryl portion often has 6 to 20 carbon atoms, 6 to 18 carbon atoms, 6 to 16 carbon atoms, 6 to 12 carbon atoms, or 6 to 10 carbon atoms.

The term “aralkylene” refers to a divalent group that is an alkylene group substituted with an aryl group or an alkylene group attached to an arylene group. The term “alkarylene” refers to a divalent group that is an arylene group substituted with an alkyl group or an arylene group attached to an alkylene group. Unless otherwise indicated, for both groups, the alkyl or alkylene portion typically has from 1 to 20 carbon atoms, 1 to 10 carbon atoms, 1 to 6 carbon atoms, or 1 to 4 carbon atoms. Unless otherwise indicated, for both groups, the aryl or arylene portion typically has from 6 to 20 carbon atoms, 6 to 18 carbon atoms, 6 to 16 carbon atoms, 6 to 12 carbon atoms, or 6 to 10 carbon atoms.

The term “catenated heteroatom” means an atom other than carbon (for example, oxygen, nitrogen, or sulfur) that replaces one or more carbon atoms in a carbon chain (for example, so as to form a carbon-heteroatom-carbon chain or a carbon-heteroatom-heteroatom-carbon chain).

The term “cure” means conversion to a crosslinked polymer network (for example, through catalysis). A “curable composition” refers to a composition that can be cured.

The term “epoxy group” refers to a functional group that consists of an oxygen atom joined by single bonds to two adjacent carbon atoms, thus forming the three-membered epoxide ring.

The term “fluoro-” (for example, in reference to a group or moiety, such as in the case of “fluoroalkylene” or “fluoroalkyl” or “fluorocarbon”) or “fluorinated” means only partially fluorinated such that there is at least one carbon-bonded hydrogen atom.

The term “fluorochemical” means fluorinated or perfluorinated chemical.

The term “heteroorganic” means an organic group or moiety (for example, an alkyl or alkylene group) containing at least one heteroatom (preferably, at least one catenated heteroatom).

The term “hydrolyzable group” or “hydrolyzable functional group” refer to a group that can react with water having a pH of 1 to 10 under conditions of atmospheric pressure. The hydrolyzable group is often converted to a hydroxyl group when it reacts. The hydroxyl group often undergoes further reactions. Typical hydrolyzable groups include, but are not limited to, alkoxy, aryloxy, aralkyloxy, acyloxy, or halo. As used herein, the term is often used in reference to one of more groups bonded to a silicon atom in a silyl group.

The term “hydrosilyl” refers to a monovalent moiety or group comprising a silicon atom directly bonded to a hydrogen atom (for example, the hydrosilyl moiety can be of formula —Si(R^{a})₃₋ₘ(H)ₘ, where m is an integer of 1, 2, or 3 and R^{a} is a hydrolyzable group or is a non-hydrolyzable group other than hydroxyl (preferably, a non-hydrolyzable group) such as alkyl or aryl).

The term “hydrosilyl equivalency” refers to the mole fraction of Si—H, which can be determined using ²⁹Si NMR and calculated as follows: collect quantitative silicon 29 NMR spectrum; reference NMR spectrum to D component (Me₂SiO_{2/2}) at roughly −20 ppm and DH component (MeHSiO_{2/2}) at roughly −35 ppm; integrate these two regions; calculate mol % DH found at −35 ppm by dividing the integrated value for the DH component by the total integrated value for the D+DH components; and report value as mol DH.

The term “isocyanate group” is a functional group with the formula —N═C═O.

The term “(meth)acrylate group” is a functional group that refers to an acrylate group of the formula CH₂═CH—C(O)O— and a methacrylate group of the formula CH₂═C(CH₃)—C(O)O—.

The term “oligomer” means a molecule that comprises at least two repeat units and that has a molecular weight less than its entanglement molecular weight; such a molecule, unlike a polymer, exhibits a significant change in properties upon the removal or addition of a single repeat unit.

The term “oxy” means a divalent group or moiety of formula —O—.

The term “perfluoro-” (for example, in reference to a group or moiety, such as in the case of “perfluoroalkylene” or “perfluoroalkyl” or “perfluorocarbon”) or “perfluorinated” means completely fluorinated such that, except as may be otherwise indicated, there are no carbon-bonded hydrogen atoms replaceable with fluorine.

The term “perfluoroether” means a group or moiety having two saturated or unsaturated perfluorocarbon groups (linear, branched, cyclic (preferably, alicyclic), or a combination thereof) linked with an oxygen atom (that is, there is one catenated oxygen atom).

The term “perfluoropolyether group (or segment or moiety)” means a group or moiety having three or more saturated or unsaturated perfluorocarbon groups (linear, branched, cyclic (preferably, alicyclic), or a combination thereof) linked with oxygen atoms (that is, there are at least two catenated oxygen atoms).

The term “thiocyanate group” is a functional group with the formula —S═C═N.

The term “thiol group” is a functional group with the formula —SH.

The term “ureido group” is a functional group with the formula —NH—C(O)—NH₂.

The term “vinyl group” is a functional group with the formula —CH═CH₂.

The term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the phrases “at least one” and “one or more.” The phrases “at least one of”0 and “comprises at least one of” followed by a list refers to any one of the items in the list and any combination of two or more items in the list.

The term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list.

### DETAILED DESCRIPTION OF ILLUSTRATIVE EMBODIMENTS

The present disclosure provides curable compositions, methods, and articles. The compositions provide a balance of desirable properties on a variety of substrates, such as glass, plastic, metal, a painted surface, or a combination thereof, which may form a portion of a vehicle.

In certain embodiments, the present disclosure provides a curable composition including: at least one polyorganosiloxane including at least one hydrosilyl moiety (in certain embodiments, two different polyorganosiloxanes); and at least one base selected from an amidine, a guanidine, a phosphazene, a proazaphosphatrane, and a combination thereof. In certain embodiments, the curable composition includes at least one silane including hydrolyzable functionality.

In certain embodiments, compositions of the present disclosure include at least one non-halogenated organic solvent having a boiling point of at least 160° C.

In certain embodiments, compositions of the present disclosure have a volatile organic content (VOC) of no more than 750 grams per linter (g/L) (or no more than 500 g/L, or no more than 250 g/L). In this context, the terms “volatile organic content” and “VOC” refer to the volatility of the composition as measured by ASTM D6886-18 (Standard Test Method for Determination of the Weight Percent Individual Volatile Organic Compounds in Waterborne Air-Dry Coatings by Gas Chromatography). This test uses methyl palmitate as a reference marker. A compound that elutes prior to the marker is considered VOC while a compound that elutes after the marker is not considered VOC. A “non-VOC” compound refers to a compound that elutes after the methyl palmitate marker.

### Polyorganosiloxanes

Compositions of the present disclosure include a polyorganosiloxane that includes hydrosilyl functionality. The polyorganosiloxane can be a small molecule, oligomer, polymer, or a combination thereof. In certain embodiments, the polyorganosiloxane is an oligomer or a polymer.

Suitable polyorganosiloxanes that include at least one hydrosilyl moiety (i.e., a monovalent moiety comprising a hydrogen atom bonded directly to a silicon atom), or at least two hydrosilyl moieties, or at least three hydrosilyl moieties.

The polysiloxanes having hydrosilyl functionality can be acyclic (linear or branched), cyclic, or a combination thereof. Useful polymers include those that have random, alternating, block, or graft structures, or a combination thereof.

In certain embodiments, the polysiloxanes having hydrosilyl functionality can be used in the curable composition of the invention singly or in the form of mixtures of different polysiloxanes. For example, curable compositions of the present disclosure may include at least two different polyorganosiloxanes, each including a different hydrosilyl equivalency.

The hydrosilyl equivalency, reported as the mole fraction of Si—H, can be determined using ²⁹Si NMR. In certain embodiments, each polyorganosiloxane has a hydrosilyl equivalency, reported as the mole fraction of Si—H, of at least 20 mol-% DH, calculated using this method. In certain embodiments, each polyorganosiloxane has a hydrosilyl equivalency, reported as the mole fraction of Si—H, of up to 100 mol-% DH, calculated using this method.

The molecular weight and the number and nature of the hydrosilyl moieties can vary widely, depending upon, for example, the properties desired for the curable and/or cured composition. In certain embodiments, the polysiloxanes having at least one hydrosilyl moiety have a weight average molecular weight of 100 to 100,000 Daltons.

A preferred class of acyclic polysiloxanes having at least one hydrosilyl moiety includes those that can be represented by the following Formula (I):

R¹₂R²SiO(R¹₂SiO)ᵣ(HR¹SiO)ₛSiR²R¹₂

wherein:

each R¹ of Formula (I) is independently selected from alkyl, alkenyl, fluoroalkyl, aryl, fluoroaryl, cycloalkyl, fluorocycloalkyl, heteroalkyl, heterofluoroalkyl, heteroaryl, heterofluoroaryl, heterocycloalkyl, heterofluorocycloalkyl, and combinations thereof;

each R² of Formula (I) is independently hydrogen or R¹ of Formula (I);

r of Formula (I) is an integer of 0 to 1000 (or 0 to 500, or 0 to 400, or 0 to 300, or 0 to 200, or 0 to 150, or 0 to 100, or 0 to 20); and

s of Formula (I) is an integer of 1 to 1000 (or 1 to 500, or 1 to 400, or 1 to 300, or 1 to 200, or 1 to 150, or 5 to 100, or 20 to 80).

In certain embodiments of Formula (I), each R² and each R¹ is methyl, r is 0, and/or s is 40.

A preferred class of cyclic polysiloxanes having at least one hydrosilyl moiety includes those that can be represented by the following Formula (II):

cyclo-[(R¹₂SiO)ₜ(HR¹SiO)ᵥ]

wherein:

each R¹ of Formula (II) is independently selected from alkyl, alkenyl, fluoroalkyl, aryl, fluoroaryl, cycloalkyl, fluorocycloalkyl, heteroalkyl, heterofluoroalkyl, heteroaryl, heterofluoroaryl, heterocycloalkyl, heterofluorocycloalkyl, and combinations thereof;

t of Formula (II) is an integer of 0 to 60 (or 0 to 10, or 0 to 5, or 0 to 3); and

v of Formula (II) is an integer of 3 to 10 (or 3 to 8, or 3 to 5).

In certain embodiments of Formula (II), each R¹ is methyl, t is 0, and/or v is 4 or 5.

In Formulas (I) and (II) above, catenated heteroatoms in R¹ can be selected from O, N, S, P, Si, Cl, and combinations thereof (in certain embodiments, O, S, and combinations thereof, or in certain embodiments, O).

In certain embodiments of Formulas (I) and (II), each R¹ is independently selected from:
alkyl (in certain embodiments, having 1 to 8 carbon atoms);
fluoroalkyl (in certain embodiments, having 3 to 15 carbon atoms (or 3 to 10 carbon atoms); in certain embodiments, the fluoroalkyl is R_{f}CⱼH₂ⱼ₋, wherein j is an integer of 2 to 8 (or 2 to 3), and R_{f} is a fluorinated or perfluorinated alkyl group having 1 to 12 carbon atoms (or 1 to 6 carbon atoms)); and
heterofluoroalkyl (in certain embodiments, having 3 to 50 carbon atoms (or 3 to 30 carbon atoms); in certain embodiments, the heterofluoroalkyl is R_{f}′CⱼH₂ⱼ₋, wherein j is an integer of 2 to 8 (or 2 to 3), and R_{f}′ is a fluorinated or perfluorinated heteroalkyl (preferably, ether or polyether) group having 1 to 45 carbon atoms (preferably, 1 to 30 carbon atoms)), aryl, and combinations thereof.

In certain of such embodiments of Formulas (I) and (II), R_{f} is a perfluoroalkyl group; and/or R_{f}′ is a perfluoroether group, a perfluoropolyether group, or a combination thereof (more preferably, R_{f}′ is a perfluoropolyether group). Preferred R_{f}′ groups include perfluoropolyether groups that can be linear, branched, cyclic (preferably, alicyclic), or a combination thereof. The perfluoropolyether group can be saturated or unsaturated (preferably, saturated). Representative examples of useful perfluoropolyether groups include, but are not limited to, those that have perfluorinated repeating units selected from —(CₚF₂ₚ)—, —(CₚF₂ₚO)—, —(CF(Z)O)—, —(CF(Z)CₚF₂ₚO)—, —(CₚF₂ₚCF(Z)O)—, —(CF₂CF(Z)O)—, and combinations thereof, wherein p is an integer of 1 to 10 (or 1 to 8, or 1 to 6, or 1 to 4, or 1 to 3); Z is selected from perfluoroalkyl, perfluoroether, perfluoropolyether, and perfluoroalkoxy groups that are linear, branched, cyclic, or a combination thereof and that have less than or equal to 12 carbon atoms (or less than or equal to 10 carbon atoms, or less than or equal to 8 carbon atoms, or less than or equal to 6 carbon atoms, or less than or equal to 4 carbon atoms, or less than or equal to 3 carbon atoms) and/or less than or equal to 4 oxygen atoms (or less than or equal to 3 oxygen atoms, or less than or equal to 2 oxygen atoms, or zero or one oxygen atom). In these perfluoropolyether structures, different repeating units can be combined in a block, alternating, or random arrangement to form the perfluoropolyether group.

The terminal group of the perfluoropolyether group can be (CₚF₂ₚ₊₁)- or (CₚF₂ₚ₊₁₀)-, for example, wherein p is as defined above. Representative examples of useful perfluoropolyether groups include, but are not limited to, C₃F₇O(CF(CF₃)CF₂O)ₙCF(CF₃)—, C₃F₇O(CF₂CF₂CF₂O)ₙCF₂CF₂—, CF₃O(C₂F₄O)ₙCF₂—, CF₃O(CF₂O)ₙC₂F₄OKF₂—, and F(CF₂)₃O(C₃F₆O)_{q}(CF₂)₃— (wherein n has an average value of 0 to 50, or 1 to 50, or 3 to 30, or 3 to 15, or 3 to 10; and q has an average value of 0 to 50, or 3 to 30, or 3 to 15, or 3 to 10).

In certain of such embodiments of Formulas (I) and (II), the perfluoropolyether group comprises at least one divalent hexafluoropropyleneoxy group (—CF(CF₃)—CF₂O—). Preferred perfluoropolyether groups include F[CF(CF₃)CF₂O]ₐCF(CF₃)— (or, as represented above, C₃F₇O(CF(CF₃)CF₂O)ₙCF(CF₃), where n+1=a), wherein a has an average value of 4 to 20. Such perfluoropolyether groups can be obtained through the oligomerization of hexafluoropropylene oxide and can be preferred because of their relatively benign environmental properties.

In certain embodiments of Formulas (I) and (II), each R¹ is independently selected from methyl, F[CF(CF₃)CF₂O]ₐCF(CF₃)CⱼH₂ⱼ₋ (wherein j is an integer of 2 to 8 (or 2 to 3) and a has an average value of 4 to 20), C₄F₉C₃H₆₋, C₄F₉C₂H₄₋, C₄F₉OC₃H₆₋, C₆F₁₃C₃H₆₋, CF₃C₃H₆₋, CF₃C₂H₄₋, phenyl, C₆H₅C₂H₄₋, and combinations thereof (even more preferably, methyl, F[CF(CF₃)CF₂O]ₐCF(CF₃)CⱼH₂ⱼ₋ (wherein j is an integer of 2 to 8 (or 2 to 3) and a has an average value of 4 to 20), CF₃C₂H₄₋, phenyl, C₄F₉C₂H₄₋, C₆F₁₃C₃H₆₋, and combinations thereof; most preferably, methyl).

Representative examples of useful acyclic, hydrosilyl-functional polysiloxanes include the following (wherein MW is weight average molecular weight; R is alkyl, aryl, or a combination thereof (preferably, alkyl; more preferably, methyl); and R_{f}″ is R_{f}CⱼH₂ⱼ₋ or R_{f}′CⱼH₂ⱼ₋, where j, R_{f}, and R_{f}′ are as defined above):
R₃SiO(R₂SiO)_{d}(RHSiO)ₑSiR₃ (for example, having a percentage of —RHSiO— units of 20 to 99 and a MW of 900 to 65,000 Daltons);
R₃SiO(RHSiO)ₑSiR₃ (for example, having a MW of 900 to 65,000 Daltons, or 1000 to 3000 Daltons);
R₃SiO(R₂SiO)d[R(R_{f}″)SiO]_{f}(RHSiO)ₑSiR₃ (for example, having a MW of 900 to 65,000 Daltons);
R₃SiO[R(R_{f}″)SiO]_{f}(RHSiO)ₑSiR₃ (for example, having a MW of 900 to 65,000 Daltons); and combinations thereof.

Representative examples of useful cyclic, hydrosilyl-functional polysiloxanes include the following (wherein MW is weight average molecular weight; R is alkyl, aryl, or a combination thereof (preferably, alkyl; more preferably, methyl); and R_{f}″ is R_{f}CⱼH₂ⱼ₋ or

R_{f}′CⱼH₂ⱼ₋, where j, R_{f}, and R_{f}′ are as defined above):
cyclo-(R₂SiO)ₓ(RHSiO)_{y} (for example, having a percentage of —RHSiO— units of 10 or greater and a MW of 150 to 1,000 Daltons (or 150 to 500 Daltons));
cyclo-(RHSiO)_{y} (for example, having a MW of 150 to 1000 Daltons (or 150 to 500 Daltons));
cyclo-(R₂SiO)ₓ[R(R_{f}″)SiO]_{z}(RHSiO)_{y} (for example, having a MW of 200 to 3000 Daltons);
cyclo-[R(R_{f}″)SiO]_{z}(RHSiO)_{y} (for example, having a MW of 200 to 3000 Daltons); and combinations thereof.

Examplary hydrosilyl-functional polysiloxanes include cyclic polymethyl(hydro)siloxane (especially 1,3,5,7-tetramethylcyclotetrasiloxane (D₄^{H}), 1,3,5,7-tetraethylcyclotetrasiloxane (Et-D₄^{H}), and 1,3,5,7,9-pentamethylcyclopentasiloxane (D₅^{H})); acyclic (linear or branched) polymethyl(hydro)siloxane; copolymer(s) (acyclic, cyclic, or a combination thereof) comprising methyl(hydro)siloxane units and (for example, up to about 80 mole percent of) other units selected from dialkylsiloxane units, (alkyl)(methyl)siloxane units, (alkyl)(phenyl)siloxane units, di(fluoroalkyl)siloxane units, di(heterofluoroalkyl)siloxane units, (fluoroalkyl)(alkyl)siloxane units, (heterofluoroalkyl)(alkyl)siloxane units, (heterofluoroalkyl)(phenyl)siloxane units, (fluoroalkyl)(phenyl)siloxane units, diphenylsiloxane units, and combinations thereof (wherein each alkyl group is independently selected from alkyl groups having one to 8 carbon atoms (for example, hexyl), each fluoroalkyl group is independently selected from fluoroalkyl groups having 3 to 15 carbon atoms, and each heterofluoroalkyl group is independently selected from heterofluoroalkyl groups having 3 to 50 carbon atoms; and combinations thereof.

Although homopolymers are often preferred, copolymers can be preferred for some applications.

The polysiloxanes can be prepared by known synthetic methods and many are commercially available (for example, from Dow Corning Corporation, Midland, Mich., or from Gelest, Inc., Morrisville, Pa. (see, for example, the polysiloxanes described in Silicon Compounds: Silanes and Silicones, Second Edition, edited by B. Arkles and G. Larson, Gelest, Inc. (2008)). Fluorinated polyorganosiloxanes can be prepared by using known synthetic methods including the platinum-catalyzed addition reaction of a fluorinated olefin and a hydrosiloxane (small molecule, oligomer, or polymer).

In certain embodiments, the composition includes at least 1 wt-%, at least 5 wt-%, or at least 10 wt-%, of at least one polyorganosiloxane comprising at least one hydrosilyl moiety, based on the total weight of the composition.

In certain embodiments, the composition includes up to 99 wt-%, up to 95 wt-%, or up to 90 wt-%, of at least one polyorganosiloxane comprising at least one hydrosilyl moiety, based on the total weight of the composition.

### Silanes

Certain embodiments of compositions of the present disclosure include a silane that includes hydrolyzable functionality. Certain embodiments of compositions of the present disclosure include a mixture of silanes that include hydrolyzable functionality.

In certain embodiments, the silane is a compound of the following Formula (IIIa):

R¹ₙ[Si(X)₄₋ₙ]ₘ

wherein:

m of Formula (IIIa) is 1 to 6;

n of Formula (IIIa) is 1 or 2; and

each R¹ of Formula (IIIa) may be monovalent or multivalent, and is independently selected from an alkyl, alkylene, aryl, arylene, alkarylene, alkaryl, aralkylene, aralkyl, which may include a straight chain, branched, and/or cyclic group, having 1 to 18 carbon atoms, optionally containing one or more catenated heteroatoms selected from O, N, S, P, Si, Cl, and optionally containing one or more functional groups selected from an amino, epoxy, thiol, (meth)acrylate, vinyl, allyl, isocyanate, thiocyanate, ureido, and chloro; and

each X of Formula (IIIa) is independently a hydrolyzable functional group selected from OR² (wherein R² is H or a (C1-C18)alkyl), or NR³R⁴ (wherein each R³ and R⁴ is independently H or a (C1-C18)alkyl or (C1-C18)alkylene).

In some embodiments, the silane compound can be partially hydrolyzed and condensed. Such compounds may be represented by the following Formula (IIIb):

X—[Si(R¹)(X)—O]ᵣ—Si(R¹)(X)₂

wherein:

r of Formula (IIIb) is 1 to 20;

each R¹ of Formula (IIIb) is monovalent and as defined above for R¹ in Formula (IIIa); and

each X of Formula (IIIb) is as defined above for X in Formula (IIIa).

In some embodiments, the silane compound may be a cyclic azasilane. Such compounds may be represented by the following Formula (IIIc):

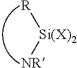

wherein:

R of Formula (IIIc) is an alkylene having 2 to 5 carbon atoms;

R′ of Formula (IIIc) is monovalent and as defined above for R¹ in Formula (IIIa); and

each X of Formula (IIIc) is as defined above for X in Formula (IIIa).

In certain embodiments, the silane is of Formula (IIIa). In certain embodiments of Formula (IIIa), m is 1 or 2. In certain embodiments of Formula (IIIa), m is 1.

In certain embodiments of Formula (IIIa), n is 1.

In certain embodiments of Formula (IIIa), each R¹ includes one or more oxygen atoms.

In certain embodiments of Formula (IIIa), each R¹ includes one or more functional groups selected from an amino, epoxy, thiol, (meth)acrylate, vinyl, allyl, isocyanate, thiocyanate, ureido, and chloro. In certain embodiments of Formula (IIIa), each R¹ includes an amino group. In certain embodiments of Formula (IIIa), each R¹ includes a primary amino group, a secondary amino group, a tertiary amino group, or a mixture of primary, secondary and tertiary amino groups.

In certain embodiments of Formula (IIIa), each X is OR² (wherein R² is H or a (C1-C18)alkyl). In certain embodiments of Formula (IIIa), each R² is independently methyl.

Suitable silane compounds are described in Silane Coupling Agents: Connecting Across Boundaries (3^{rd} Edition), by Barry Arkles, 2014, Gelest Inc., Morrisville, Pa. Examples of suitable silanes of Formula (IIIa) include aminopropyltrimethoxysilane, methacryloxypropyltrimethoxysilane, 3-glycidoxypropyltrimethoxysilane, isooctyltrimethoxysilane, 3-mercaptopropyltrimethoxysilane, and bis 3-trimethoxysilylpropylamine.

In certain embodiments, the composition includes at least 0.1 wt-%, at least 0.01 wt-%, or at least 0.001 wt-%, of at least one silane comprising at least one hydrolyzable group, based on the total weight of the composition.

In certain embodiments, the composition includes up to 10 wt-%, up to 5 wt-%, or up to 1 wt-%, of at least one silane comprising at least one hydrolyzable group, based on the total weight of the composition.

### Bases

Bases suitable for use in the curable composition of the disclosure include amidines, guanidines (including substituted guanidines such as biguanides), phosphazenes, proazaphosphatranes (also known as Verkade's bases), and combinations thereof. Self-protonatable forms of the bases (for example, aminoacids such as arginine) generally are less suitable and therefore excluded, as such forms are self-neutralized and therefore insoluble in the curable composition.

In certain embodiments, suitable bases include amidines, guanidines, and combinations thereof. In certain embodiments, suitable bases include amidines and combinations thereof. In certain embodiments, suitable bases include cyclic amidines and combinations thereof.

Such classes of bases can effectively catalyze the moisture curing of the polyorganosiloxanes of the present disclosure. The bases can be used in the curable composition singly (individually) or in the form of mixtures of one or more different bases (including bases from different structural classes). If desired, the base(s) can be present in photolatent form (for example, in the form of an activatable composition that, upon exposure to radiation or heat, generates the base(s) in situ).

Useful amidines include those that can be represented by the following Formula (IV):

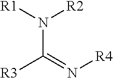

wherein R1, R2, R3, and R4 are each independently selected from hydrogen, monovalent organic groups, monovalent heteroorganic groups (e.g., including nitrogen, oxygen, phosphorus, or sulfur in the form of groups or moieties that are bonded through a carbon atom and that do not contain acid functionality such as carboxylic or sulfonic acid), and combinations thereof; and wherein any two or more of R1, R2, R3, and R4 optionally can be bonded together to form a ring structure (e.g., a five-, six-, or seven-membered ring; in certain embodiments, a six- or seven-membered ring; in certain embodiments, a six-membered ring). In certain embodiments, the organic and heteroorganic groups have from 1 to 20 carbon atoms (or from 1 to 10 carbon atoms, or from 1 to 6 carbon atoms). In certain embodiments of Formula (IV), R4 is not hydrogen.

In certain embodiments, amidines that include at least one ring structure (that is, cyclic amidines) are used. In certain embodiments, cyclic amidines that include two ring structures (that is, bicyclic amidines) are used.

Representative examples of useful amidine compounds include 1,2-dimethyl-1,4,5,6-tetrahydropyrimidine, 1-ethyl-2-methyl-1,4,5,6-tetrahydropyrimidine, 1,2-diethyl-1,4,5,6-tetrahydropyrimidine, 1-n-propyl-2-methyl-1,4,5,6-tetrahydropyrimidine, 1-isopropyl-2-methyl-1,4,5,6-tetrahydropyrimidine, 1-ethyl-2-n-propyl-1,4,5,6-tetrahydropyrimidine, 1-ethyl-2-isopropyl-1,4,5,6-tetrahydropyrimidine, DBU (i.e., 1,8-diazabicyclo[5.4.0]-7-undecene), DBN (that is, 1,5-diazabicyclo[4.3.0]-5-nonene), and the like, and combinations thereof. Preferred amidines include 1,2-dimethyl-1,4,5,6-tetrahydropyrimidine, DBU (i.e., 1,8-diazabicyclo[5.4.0]-7-undecene), DBN (that is, 1,5-diazabicyclo[4.3.0]-5-nonene), and combinations thereof.

In certain embodiments, the amidine compounds include DBU, DBN, and combinations thereof In certain embodiments, the amidine compound is DBU.

Useful guanidines include those that can be represented by the following Formula (V):

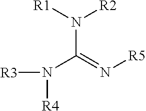

wherein R1, R2, R3, R4, and R5 are each independently selected from hydrogen, monovalent organic groups, monovalent heteroorganic groups (e.g., including nitrogen, oxygen, phosphorus, or sulfur in the form of groups or moieties that are bonded through a carbon atom and that do not contain acid functionality such as carboxylic or sulfonic acid), and combinations thereof; and wherein any two or more of R1, R2, R3, R4, and R5 optionally can be bonded together to form a ring structure (e.g., a five-, six-, or seven-membered ring; in certain embodiments, a six- or seven-membered ring; in certain embodiments, a six-membered ring). In certain embodiments, the organic and heteroorganic groups have from 1 to 20 carbon atoms (or from 1 to 10 carbon atoms, or from 1 to 6 carbon atoms). In certain embodiments of Formula (V), R5 is not hydrogen.

In certain embodiments, guanidines that include at least one ring structure (that is, cyclic quanidines) are used. In certain embodiments, cyclic guanidines that include two ring structures (that is, bicyclic guanidines) are used.

Representative examples of useful guanidine compounds include 1-methylguanidine, 1-n-butylguanidine, 1,1-dimethylguanidine, 1,1-diethylguanidine, 1,1,2-trimethylguanidine, 1,2,3-trimethylguanidine, 1,3-diphenylguanidine, 1,1,2,3,3-pentamethylguanidine, 2-ethyl-1,1,3,3-tetramethylguanidine, 1,1,3,3-tetramethyl-2-n-propylguanidine, 1,1,3,3-tetramethyl-2-isopropylguanidine, 2-n-butyl-1,1,3,3-tetramethylguanidine, 2-tert-butyl-1,1,3,3-tetramethylguanidine, 1,2,3-tricyclohexylguanidine, TBD (i.e., 1,5,7-triazabicyclo[4.4.0]dec-5-ene), MTBD (i.e., 7-methyl-1,5,7-triazabicyclo[4.4.0]dec-5-ene), 7-ethyl-1,5,7-triazabicyclo[4.4.0]dec-5-ene, 7-n-propyl-1,5,7-triazabicyclo[4.4.0]dec-5-ene, 7-isopropyl-1,5,7-triazabicyclo[4.4.0]dec-5-ene, 7-n-butyl-1,5,7-triazabicyclo[4.4.0]dec-5-ene, 7-isobutyl-1,5,7-triazabicyclo[4.4.0]dec-5-ene, 7-tert-butyl-1,5,7-triazabicyclo[4.4.0]dec-5-ene, 7-cyclohexyl-1,5,7-triazabicyclo[4.4.0]dec-5-ene, 7-n-octyl-1,5,7-triazabicyclo[4.4.0]dec-5-ene, 7-2-ethylhexyl-1,5,7-triazabicyclo[4.4.0]dec-5-ene, 7-decyl-1,5,7-triazabicyclo[4.4.0]dec-5-ene, biguanide, 1-methylbiguanide, 1-n-butylbiguanide, 1-(2-ethylhexyl)biguanide, 1-n-octadecylbiguanide, 1,1-dimethylbiguanide, 1,1-diethylbiguanide, 1-cyclohexylbiguanide, 1-allylbiguanide, 1-n-butyl-N2-ethylbiguanide, 1,1′-ethylenebisguanide, 1-[3-(diethylamino)propyl]biguanide, 1-[3-(dibutylamino)propyl]biguanide, N′,N″-dihexyl-3,12-diimino-2,4,11,13-tetraazatetradecanediamidine, and the like, and combinations thereof.

In certain embodiments, the guanidine compounds include TBD (i.e., 1,5,7-triazabicyclo[4.4.0]dec-5-ene), MTBD (i.e., 7-methyl-1,5,7-triazabicyclo[4.4.0]dec-5-ene), 2-tert-butyl-1,1,3,3-tetramethylguanidine, and combinations thereof. In certain embodiments, the guanidine compounds include TBD, MTBD, and combinations thereof.

If desired, the amidines and guanidines can be selected from those exhibiting a pH value lower than 13.4 when measured according to JIS Z 8802 (e.g., 1,3-diphenylguanidine, DBU, DBN, or a combination thereof; in certain embodiments, DBU, DBN, or a combination thereof). The referenced method for determining the pH of aqueous solutions, JIS Z 8802, is carried out by first preparing an aqueous solution of base by adding 5 millimoles of base to 100 grams of a mixed solvent composed of isopropyl alcohol and water in a weight ratio of 10:3. The pH of the resulting solution is then measured at 23° C. using a pH meter (for example, a Horiba Seisakusho Model F-22 pH meter).

Useful phosphazenes include those that can be represented by the following Formula (VI):

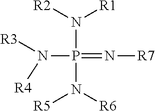

wherein R1, R2, R3, R4, R5, R6, and R7 are each independently selected from hydrogen, monovalent organic groups, monovalent heteroorganic groups (e.g., comprising nitrogen, oxygen, phosphorus, or sulfur in the form of groups or moieties that are bonded through a carbon atom and that do not contain acid functionality such as carboxylic or sulfonic acids), and combinations thereof; and wherein any two or more of R1, R2, R3, R4, R5, R6, and R7 optionally can be bonded together to form a ring structure (e.g., a five-, six-, or seven-membered ring; in certain embodiments, a five- or six-membered ring; in certain embodiments, a six-membered ring). In certain embodiments, the organic and heteroorganic groups have from 1 to 20 carbon atoms (or from 1 to 10 carbon atoms, or from 1 to 6 carbon atoms). In certain embodiments of Formula (V), R7 is not hydrogen.

Representative examples of useful phosphazene compounds include those listed in U.S. Pat. No. 9,175,188 (Buckanin et al.). In certain embodiments, the phosphazenes include 2-tert-butylimino-2-diethylamino-1,3-dimethylperhydro-1,3,2-diazaphosphorine, phosphazene base P₁-t-Bu-tris(tetramethylene), phosphazene base P₄-t-Bu, and combinations thereof.

Useful proazaphosphatrane bases (Verkade's bases) include those that can be represented by the following Formula (VII):

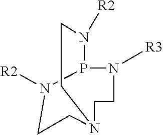

wherein R1, R2, and R3 are each independently selected from hydrogen, monovalent organic groups, monovalent heteroorganic groups (e.g., comprising nitrogen, oxygen, phosphorus, or sulfur in the form of groups or moieties that are bonded through a carbon atom and that do not contain acid functionality such as carboxylic or sulfonic acids), and combinations thereof (less preferably hydrogen). In certain embodiments, the organic and heteroorganic groups have from 1 to 20 carbon atoms (or from 1 to 10 carbon atoms, or from 1 to 6 carbon atoms).

Representative examples of useful proazaphosphatrane compounds include those listed in U.S. Pat. No. 9,175,188 (Buckanin et al.), such as 2,8,9-triisopropyl-2,5,8,9-tetraaza-1-phosphabicyclo[3.3.3]undecane, 2,8,9-trimethyl-2,5,8,9-tetraaza-1-phosphabicyclo[3.3.3]undecane, and 2,8,9-triisobutyl-2,5,8,9-tetraaza-1-phosphabicyclo[3.3.3]undecane, 2,8,9-trimethyl-2,5,8,9-tetraaza-1-phosphabicyclo[3.3.3]undecane. In certain embodiments, 2,8,9-triisopropyl-2,5,8,9-tetraaza-1-phosphabicyclo[3.3.3]undecane is a preferred proazaphosphatrane compound.

In certain embodiments, the composition includes at least 0.01 wt-%, at least 0.001 wt-%, or at least 0.0001 wt-%, of at least one base, based on the total weight of the composition.

In certain embodiments, the composition includes up to 5 wt-%, up to 2.5 wt-%, or up to 1 wt-%, of at least one base, based on the total weight of the composition.

### Organic Solvents

Suitable organic solvents include non-halogenated organic solvents having a boiling point of at least 160° C. Non-halogenated organic solvents include organic solvents that do not include halogen atoms (e.g., chlorine, bromine), such as halogenated solvents like 1,2-dichlorobenzene. Such halogenated solvents may have adverse health effects.

Suitable solvents can be selected to yield a curable composition that has good spreading characteristics, that can be easily applied to a surface, that does not evaporate too quickly or too slowly, and that permits excess coating composition to be removed without creating streaks that impair the appearance of the finished, coated surface, and that solubilize other components of the composition, but does not solubilize components of the underlying coatings (e.g., paint, plastic, glass). Combinations of solvents may be used to impart desired properties to the composition.

Suitable solvents for use in the curable composition of the invention include aprotic solvents such as:

isoparaffins (e.g., oil-like, fully-saturated, linear and/or branched aliphatic hydrocarbons having around 9 to 13 carbon atoms, such as those commercially available under the trade name “ISOPAR” from ExxonMobil Chemical Co., Houston, Tex., especially ISOPAR L, ISOPAR H, ISOPAR K, ISOPAR M, and ISOPAR N);

aromatic fluids (e.g., those produced from petroleum-based raw materials and have an aromatic content of 99% or greater and are composed primarily of C9-C10 dialkyl and trialkylbenzenes, such as those commercially available under the trade name “SOLVESSO” from Brenntag Solvents, Warington, UK, especially Aromatic 100 and Aromatic 200);

dearomatized fluids (e.g., aliphatic solvents that include a low amount of aromatic hydrocarbon solvents, in which the major components include normal alkanes, isoalkanes, and cyclics, such as those commercially available under the trade name “EXXSOL” from ExxonMobil Chemical Co., Houston, Tex., especially EXXSOL D40, EXXSOL D130, EXXSOL D95, and EXXSOL Methylpentane Naphtha, as well as under the trade name “DRAKESOL” from Calumet Specialty Products Partners, LP, Indianapolis, Ind., especially DRAKESOL 205);

non-dearomatized fluids (e.g., petroleum hydrocarbon distillates, such as those commercially available under the trade name “VARSOL” from ExxonMobil Chemical Co., Houston, Tex., especially VARSOL 1, VARSOL 18, VARSOL 60, and VARSOL 110);

paraffins (e.g., refined petroleum solvents including predominantly C7-C11 hydrocarbons, typically 55% paraffins, 30% monocycloparaffins, 2% dicycloparaffins, and 12% alkylbenzenes, such as VM&P Naptha commercially available from Sunnyside Corp., Wheeling, Ill., Startex Chemicals., Woodlands, Tex., or Spectrum Chemical, New Brunswick, N.J.));

glycol ethers or esters (e.g., solvents based on alkyl ethers and diethers of ethylene glycol or propylene glycol, such as those commercially available under the trade names “DOWANOL” and “PROGLYDE” from Dow Chemical Co., Midland, Mich., or Lyondell Basell, Houston, Tex., especially DOWANOL Eph (ethylene glycol phenyl ether), DOWANOL PGDA (propylene glycol diacetate), DOWANOL DPM (di(propylene glycol) methyl ether), DOWANOL DPMA (di(propylene glycol) methyl ether acetate), DOWANOL LoV 485 Coalescent glycol ether, and PROGLYDE DMM (dipropylene glycol dimethyl ether), as well as the ester Butyl Carbitol Acetate (diethylene glycol n-butyl ether acetate));

esters (e.g., isoamyl acetate (3-methylbutyl acetate) and ethyl benzoate);

ketones (e.g., diisobutylketone, isobutylheptylketone, and Isophorone (an α,β-unsaturated cyclic ketone));

amides (e.g., dimethylformamide);

cyclosiloxanes (such as those commercially available under the trade name “PMX” from Dow Chemical Co., Midland, Mich., or Univar, Downers Grove, IL, such as PMX-245 (cyclopentasiloxane) and PMX-246 (cyclohexasiloxane); and

monoterpenes (e.g., d-limonene and Pinene).

The amount of solvent should be sufficient to prevent the curable composition from evaporating too quickly during application, which may cause the coating composition to have a streaky appearance or otherwise make it difficult to wipe off any excess composition. Too much solvent may evaporate too slowly or be difficult to apply.

In certain embodiments, the composition includes at least 1 wt-%, at least 5 wt-%, or at least 10 wt-%, of at least one non-halogenated organic solvent having a boiling point of at least 160° C., based on the total weight of the composition.

In certain embodiments, the composition includes up to 99 wt-%, up to 95 wt-%, or up to 90 wt-%, of at least one non-halogenated organic solvent having a boiling point of at least 160° C., based on the total weight of the composition.

### Preparation of Curable Compositions

The curable composition of the invention can be prepared by combining the various components, preferably, with agitation or stirring. The composition can be maintained as a relatively shelf-stable, 2-part system (for example, by keeping the base separate from the polyorganosiloxane and silane compounds), if desired, but a 1-part system (comprising the base, polyorganosiloxane, and silane) can also be stable (such that there is no gelling or precipitation, for example) for periods of at least two months, and often up to 1 year, or 5 years, or even longer if in dry solvent and packaged to exclude moisture, prior to coating or other application of the composition.

The curable composition includes the base, polyorganosiloxane, and silane in the amounts described above. Minor amounts of optional components can be added to the curable composition to impart particular desired properties for particular curing methods or uses. Useful compositions can include conventional additives such as, for example, catalysts (including conventional condensation catalysts such as tin catalysts, which can be added as co-catalysts if desired), initiators, emulsifiers (including surfactants), stabilizers, anti-oxidants, flame retardants, adhesion promoters (for example, trialkoxysilanes), release modifiers (for example, silicate resins including silicate MQ resin), colorants, polysiloxanes (for example, polydimethylsiloxane) having no reactive silane functionality, thickeners (for example, carboxy methyl cellulose (CMC), polyvinylacrylamide, polypropylene oxide, polyethylene oxide/polypropylene oxide copolymers, polyalkenols), and the like, and mixtures thereof.

### Use and Curing of Curable Compositions

The curable coating compositions are easy to use. Typically, a small amount of curable composition is applied to the surface to be treated. For example, approximately 6 drops/ft² (65 drops/m²) may be used, depending on the condition of the surface being treated (weathered or deteriorated surfaces may benefit from using a larger amount of the protective coating composition). The curable composition may be applied to a surface either directly using a variety of techniques (e.g., spraying), or the composition may be first applied to a spreading device (e.g., a cloth) and then applied to a surface. In one convenient approach, the curable composition may be evenly distributed on a surface in one step, by hand-wiping with a clean, dry cloth or pad (for example, a suede or microfiber cloth or a foam pad) using overlapping circular strokes.

After a cure window of typically at least 0.1 minute, or at least 1 minute, and preferably no more than 30 minutes, excess composition may be wiped off and the coating allowed to further cure. Preferably, the composition cures sufficiently for excess to be wiped off within an optimal cure window of 3 to 5 minutes. In certain embodiments, cure conditions of 70° F.±5° F. (21.1° C.±2.8° C.) and 50%±3% relative humidity are used. Shorter or longer drying times are not particularly problematic, but may inconvenience the user. The coated surface is then typically hand-buffed with a clean, dry cloth of cotton, synthetic or natural microfibers, or other suitable material using overlapping circular strokes.

Certain embodiments generate a clear, streak-free, and in some cases, a glass-like, finish on the coated surface. Although not required, it is preferred that the coating cure for a total of 20 to 60 minutes, or 45 to 60 minutes, under dry conditions.

The properties of a cured coating formed from curable compositions according to certain exemplary embodiments promote excellent water-beading on painted metal surfaces to which they have been applied, encouraging a large number of small, well-rounded, hemispherical water drops to form or “bead up.” These will evaporate more quickly than a smaller number of larger, flatter water droplets that are more likely to form on painted metal surfaces that have not been treated with the protective coating composition. Thus, a curable coating composition as described herein may promote faster drying of a surface that has been coated therewith and that subsequently becomes wet.

Cured coatings formed from curable compositions according to certain exemplary embodiments may also facilitate the release of water from surfaces to which they have been applied. Water applied to such a surface (for example, from precipitation or rinse water used to wash and clean a painted metal surface) will be readily released from or “run off” the surface, thereby reducing the water marks or water spots that may have to be removed once any water that remains on the coated surface evaporates. For example, water dripped onto a 4 inch by 4 inch (10.16 cm by 10.16 cm) section of a painted motor vehicle panel positioned at a 60° angle (the panel having been treated with certain embodiments of the protective coating composition) will run off that section of the panel in 6 to 10 seconds, or in 5 seconds or less.

Desirably, the curable coating compositions may provide sufficient durability to maintain acceptable performance and a desired appearance even after the coated surface has been subjected to repeated washing and rinsing cycles. For example, a painted motor vehicle panel that has been treated with certain embodiments of a curable composition described herein may still promote excellent water-beading, encouraging a large number of small, well-rounded, hemispherical water drops to form or “bead up” even after more than 100 back-and-forth wiping motions (cycles) with a soft foam pad that has been saturated with a 5% aqueous automotive shampoo solution, or more than 200 cycles, or more than 250 cycles.

In certain embodiments, the coating is at least partially cured. With time, a coating will more fully cure, and typically completely cure.

In certain embodiments, a coating is prepared from a curable composition as described herein and cured using the Coating Panel Preparation Method in the Examples Section, wherein a coating composition is applied twice and each time allowed to cure for 45 seconds before the excess coating solution is removed, with 30 minutes between coats, and the second coating allowed to further cure for 24 hours in a controlled temperature and humidity room set at 72° F. and 50% relative humidity. In certain embodiments, coatings cured in this manner display at least one of the following properties: a Coefficient of Friction of less than 0.6 measured according to the Coefficient of Friction Test Method in the Examples Section; a receding contact angle of greater than 90 measured according to the Water Contact Angle Test Method of the Examples Section; and a receding contact angle of greater than 80 after 500 scrubs (made according to the Panel Scrub Test Method in the Examples Section) measured according to the Water Contact Angle Test Method in the Examples Section.

In certain embodiments, a coating, prepared from a curable composition as described herein and cured using the Coating Panel Preparation Method in the Examples Section, does not decrease the gloss of a substrate by more than 2% compared to the substrate without the coating disposed thereon, as measured using the Gloss Test Method in the Examples Section.

In certain embodiments, the substrates includes glass, plastic, metal, a painted surface, or a combination thereof.

In certain embodiments, the substrate is transparent.

In certain embodiments, a coating, prepared from a curable composition as described herein and cured using the Coating Panel Preparation Method in the Examples Section, has a haze of less than 0.5%, as measured using the Haze Test Method in the Example Section.

While the various embodiments have been particularly described in the context of painted metal panels such as found in motor vehicles, this is only by way of example and to facilitate understanding these embodiments. Certain embodiments could also be applied to surfaces other than painted metal panels such as bare metal panels, polymeric surfaces such as those derived from polyurethane or acrylic resins, and glass.

In addition, while the various embodiments have particular utility for motor vehicles, other applications are contemplated such as use on surfaces associated with marine and aerospace environments, household uses (e.g., tub and shower enclosures), and for building maintenance (e.g., windows).

### EXEMPLARY EMBODIMENTS

Embodiment 1 is a curable composition comprising (or consisting essentially of): at least one polyorganosiloxane comprising at least one hydrosilyl moiety; at least one silane comprising hydrolyzable functionality; and at least one base selected from an amidine, a guanidine, a phosphazene, a proazaphosphatrane, and a combination thereof.

Embodiment 2 is the composition of embodiment 1 further comprising at least one non-halogenated organic solvent having a boiling point of at least 160° C.

Embodiment 3 is the composition of embodiment 2, wherein the non-halogenated organic solvent is an aprotic solvent.

Embodiment 4 is the composition of embodiment 2 or 3, wherein the organic aprotic solvent is selected from:

isoparaffins (e.g., oil-like, fully-saturated, linear and/or branched aliphatic hydrocarbons having around 9 to 13 carbon atoms, such as those commercially available under the trade name “ISOPAR” from ExxonMobil Chemical Co., Houston, Tex., especially ISOPAR L, ISOPAR H, ISOPAR K, ISOPAR M, and ISOPAR N);

aromatic fluids (e.g., those produced from petroleum-based raw materials and have an aromatic content of 99% or greater and are composed primarily of C9-C10 dialkyl and trialkylbenzenes, such as those commercially available under the trade name “SOLVESSO” from Brenntag Solvents, Warington, UK, especially Aromatic 100 and Aromatic 200);

dearomatized fluids (e.g., aliphatic solvents that include a low amount of aromatic hydrocarbon solvents, in which the major components include normal alkanes, isoalkanes, and cyclics, such as those commercially available under the trade name “EXXSOL” from ExxonMobil Chemical Co., Houston, Tex., especially EXXSOL D40, EXXSOL D130, EXXSOL D95, and EXXSOL Methylpentane Naphtha, as well as under the trade name “DRAKESOL” from Calumet Specialty Products Partners, LP, Indianapolis, Ind., especially DRAKESOL 205);

non-dearomatized fluids (e.g., petroleum hydrocarbon distillates, such as those commercially available under the trade name “VARSOL” from ExxonMobil Chemical Co., Houston, Tex., especially VARSOL 1, VARSOL 18, VARSOL 60, and VARSOL 110);

paraffins (e.g., refined petroleum solvents including predominantly C7-C11 hydrocarbons, typically 55% paraffins, 30% monocycloparaffins, 2% dicycloparaffins, and 12% alkylbenzenes, such as VM&P Naptha commercially available from Sunnyside Corp., Wheeling, Ill., Startex Chemicals., Woodlands, Tex., or Spectrum Chemical, New Brunswick, N.J.));

glycol ethers or esters (e.g., solvents based on alkyl ethers and diethers of ethylene glycol or propylene glycol, such as those commercially available under the trade names “DOWANOL” and “PROGLYDE” from Dow Chemical Co., Midland, Mich., or Lyondell Basell, Houston, Tex., especially DOWANOL Eph (ethylene glycol phenyl ether), DOWANOL PGDA (propylene glycol diacetate), DOWANOL DPM (di(propylene glycol) methyl ether), DOWANOL DPMA (di(propylene glycol) methyl ether acetate), DOWANOL LoV 485 Coalescent glycol ether, and PROGLYDE DMM (dipropylene glycol dimethyl ether), as well as the ester Butyl Carbitol Acetate (diethylene glycol n-butyl ether acetate));

esters (e.g., isoamyl acetate (3-methylbutyl acetate) and ethyl benzoate);

ketones (e.g., diisobutylketone, isobutylheptylketone, and Isophorone (an α,β-unsaturated cyclic ketone));

amides (e.g., dimethylformamide);

cyclosiloxanes (such as those commercially available under the trade name “PMX” from Dow Chemical Co., Midland, Mich., or Downers Grove, Ill., such as PMX-245 (cyclopentasiloxane) and PMX-246 (cyclohexasiloxane));

monoterpenes (e.g., d-limonene and Pinene); and combinations thereof.

Embodiment 5 is the composition of any one of the preceding embodiments comprising at least 1 wt-% (or at least 5 wt-%, or at least 10 wt-%) of at least one non-halogenated organic solvent having a boiling point of at least 160° C., based on the total weight of the composition.

Embodiment 6 is the composition of any one of the preceding embodiments comprising up to 99 wt-% (or up to 95 wt-%, or up to 90 wt-%) of at least one non-halogenated organic solvent having a boiling point of at least 160° C., based on the total weight of the composition.

Embodiment 7 is the composition of any one of the preceding embodiments which is anhydrous.

Embodiment 8 is the composition of any one of the preceding embodiments, wherein the polyorganosiloxane comprises a cyclic polymethyl(hydro)siloxane, an acyclic polymethyl(hydro)siloxane, a copolymer comprising methyl(hydro)siloxane units and dimethylsiloxane units, or a combination thereof.

Embodiment 9 is the composition of any one of the preceding embodiments, wherein the polyorganosiloxane comprises at least two hydrosilyl moieties.

Embodiment 10 is the composition of embodiment 9, wherein the polyorganosiloxane comprises at least three hydrosilyl moieties.

Embodiment 11 is the composition of any one of the preceding embodiments, wherein the polyorganosiloxane comprises at least one acyclic polysiloxane that is represented by the following Formula (I):

R¹₂R²SiO(R¹₂SiO)ᵣ(HR¹SiO)ₛSiR²R¹₂

wherein:

each R¹ of Formula (I) is independently selected from alkyl, alkenyl, fluoroalkyl, aryl, fluoroaryl, cycloalkyl, fluorocycloalkyl, heteroalkyl, heterofluoroalkyl, heteroaryl, heterofluoroaryl, heterocycloalkyl, heterofluorocycloalkyl, and combinations thereof;

each R² of Formula (I) is independently hydrogen or R¹ of Formula (I);

r of Formula (I) is an integer of 0 to 1000 (or 0 to 500, or 0 to 400, or 0 to 300, or 0 to 200, or 0 to 150, or 0 to 100, or 0 to 20); and

s of Formula (I) is an integer of 1 to 1000 (or 1 to 500, or 1 to 400, or 1 to 300, or 1 to 200, or 1 to 150, or 5 to 100, or 20 to 80).

Embodiment 12 is the composition of any one of the preceding embodiments, wherein the polydiorganosiloxane comprises at least one cyclic polysiloxane that is represented by the following Formula (II):

cyclo-[(R¹₂SiO)ₜ(HR¹SiO)ᵥ]

wherein:

each R¹ of Formula (II) is independently selected from alkyl, alkenyl, fluoroalkyl, aryl, fluoroaryl, cycloalkyl, fluorocycloalkyl, heteroalkyl, heterofluoroalkyl, heteroaryl, heterofluoroaryl, heterocycloalkyl, heterofluorocycloalkyl, and combinations thereof;

t of Formula (II) is an integer of 0 to 60 (or 0 to 10, or 0 to 5, or 0 to 3); and

v of Formula (II) is an integer of 3 to 10 (or 3 to 8, or 3 to 5).

Embodiment 13 is the composition of any one of the preceding embodiments comprising at least two different polyorganosiloxanes, each comprising a different hydrosilyl equivalency.

Embodiment 14 is the composition of embodiment 13, wherein each polyorganosiloxane has a hydrosilyl equivalency, reported as the mole fraction of Si—H, of at least 20 mol-% DH, and in certain embodiments, of up to 100 mol-% DH.

Embodiment 15 is the composition of any one of the preceding embodiments, wherein the polysiloxane has at least one hydrosilyl moiety having a weight average molecular weight of at least 100 Daltons.

Embodiment 16 is the composition of any one of the preceding embodiments, wherein the polysiloxane has at least one hydrosilyl moiety having a weight average molecular weight of up to 100,000 Daltons (or up to 50,000 Daltons).

Embodiment 17 is the composition of any one of the preceding embodiments, wherein the silane is a compound of the following Formula (IIIa):

R¹ₙ[Si(X)₄₋ₙ]ₘ

wherein:

m of Formula (IIIa) is 1 to 6;

n of Formula (IIIa) is 1 or 2; and

each R¹ of Formula (IIIa) may be monovalent or multivalent, and is independently selected from an alkyl, alkylene, aryl, arylene, alkarylene, alkaryl, aralkylene, aralkyl, which may include a straight chain, branched, and/or cyclic group, having 1 to 18 carbon atoms, optionally containing one or more catenated heteroatoms selected from O, N, S, P, Si, and Cl, and optionally containing one or more functional groups selected from an amino, epoxy, thiol, (meth)acrylate, vinyl, allyl, isocyanate, thiocyanate, ureido, and chloro; and

each X of Formula (IIIa) is independently a hydrolyzable functional group selected from OR² (wherein R² is H or a (C1-C18)alkyl), or NR³R⁴ (wherein each R³ and R⁴ is independently H or a (C1-C18)alkyl or (C1-C18)alkylene).

Embodiment 18 is the composition of embodiment 17, wherein m of Formula (IIIa) is 1 or 2.

Embodiment 19 is the composition of embodiment 17 or 18, wherein n of Formula (IIIa) is 1.

Embodiment 20 is the composition of any one of embodiments 17 to 19, wherein each R¹ of Formula (IIIa) includes one or more oxygen atoms.

Embodiment 21 is the composition of any one of embodiments 17 to 20, wherein each R¹ of Formula (IIIa) includes one or more functional groups selected from an amino, epoxy, thiol, (meth)acrylate, vinyl, allyl, isocyanate, thiocyanate, and chloro.

Embodiment 22 is the composition of any one of embodiments 17 to 21, wherein each X of Formula (IIIa) is OR², wherein R² is H or a (C1-C18)alkyl.

Embodiment 23 is the composition of embodiment 22, wherein each R² of X of Formula (IIIa) is independently methyl.

Embodiment 24 is the composition of any one of embodiments 17 to 23, wherein the silane is selected from the group of aminopropyltrimethoxysilane, methacryloxypropyltrimethoxysilane, 3-glycidoxypropyltrimethoxysilane, isooctyltrimethoxysilane, 3-mercaptopropyltrimethoxysilane, and bis 3-trimethoxysilylpropylamine.

Embodiment 25 is the composition of any one of the preceding embodiments, wherein the silane is a compound of the following Formula (IIIb):

X—[Si(R¹)(X)—O]ᵣ—Si(R¹)(X)₂

wherein:

r of Formula (IIIb) is 1 to 20;

each R¹ of Formula (IIIb) is monovalent and as defined above for R¹ in Formula (IIIa); and

each X of Formula (IIIb) is as defined above for X in Formula (IIIa).

Embodiment 26 is the composition of any one of the preceding embodiments, wherein the silane is a compound of the following Formula (IIIc):

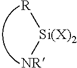

wherein:

R of Formula (IIIc) is an alkylene having 2 to 5 carbon atoms;

R′ of Formula (IIIc) is monovalent and as defined above for R¹ in Formula (IIIa); and

each X of Formula (IIIc) is as defined above for X in Formula (IIIa).

Embodiment 27 is the composition of any one of the preceding embodiments, wherein the base is selected from
an amidine compound represented by the following Formula (IV):

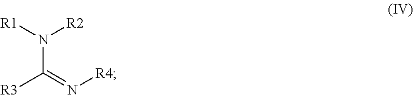

a guanidine compound represented by the following Formula (V):

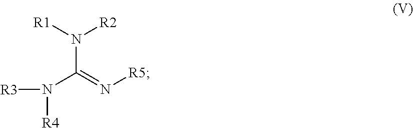

a phosphazene compound represented by the following Formula (VI):

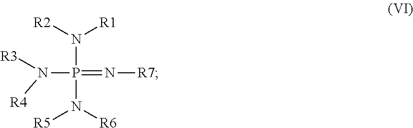

a proazaphosphatrane compound represented by the following Formula (VII):

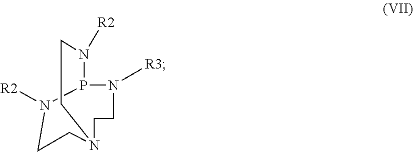

and a combination thereof;

wherein R1, R2, R3, R4, R5, R6, and R7 are each independently selected from hydrogen, monovalent organic groups, monovalent heteroorganic groups, and combinations thereof; and wherein any two or more of R1, R2, R3, R4, R5, R6, and R7 of said amidine, guanidine, and/or phosphazene compounds optionally can be bonded together to form a ring structure.

Embodiment 28 is the composition of embodiment 27, wherein the base is selected from 1,2-dimethyl-1,4,5,6-tetrahydropyrimidine, 1,8-diazabicyclo[5.4.0]-7-undecene (DBU), 1,5-diazabicyclo[4.3.0]-5-nonene (DBN), 1,5,7-triazabicyclo[4.4.0]dec-5-ene (TBD), 7-methyl-1,5,7-triazabicyclo[4.4.0]dec-5-ene (MTBD), 2-tert-butyl-1,1,3,3-tetramethylguanidine, 2-tert-butylimino-2-diethylamino-1,3-dimethylperhydro-1,3,2-diazaphosphorine, phosphazene base P1-t-Bu-tris(tetramethylene), phosphazene base P4-t-Bu, 2,8,9-triisopropyl-2,5,8,9-tetraaza-1-phosphabicyclo[3.3.3]undecane, and combinations thereof.

Embodiment 29 is the composition of embodiment 28, wherein the base is selected from an amidine, a guanidine, and a combination thereof.

Embodiment 30 is the composition of embodiment 29, wherein the base is selected from an amidine and a combination thereof.

Embodiment 31 is the composition of embodiment 30, wherein the amidine is selected from 1,8-diazabicyclo[5.4.0]-7-undecene (DBU), 1,5-diazabicyclo[4.3.0]-5-nonene (DBN), and a combination thereof.

Embodiment 32 is the composition of any one of the preceding embodiments comprising at least 1 wt-% (or at least 5 wt-%, or at least 10 wt-%) of at least one polyorganosiloxane comprising at least one hydrosilyl moiety, based on the total weight of the composition.

Embodiment 33 is the composition of any one of the preceding embodiments comprising up to 99 wt-% (or up to 95 wt-%, or up to 90 wt-%) of at least one polyorganosiloxane comprising at least one hydrosilyl moiety, based on the total weight of the composition.

Embodiment 34 is the composition of any one of the preceding embodiments comprising at least 0.1 wt-% (or at least 0.01 wt-%, or at least 0.001 wt-%) of at least one silane comprising at least one hydrolyzable group, based on the total weight of the composition.

Embodiment 35 is the composition of any one of the preceding embodiments comprising up to 10 wt-% (or up to 5 wt-%, or up to 1 wt-%) of at least one silane comprising at least one hydrolyzable group, based on the total weight of the composition.

Embodiment 36 is the composition of any one of the preceding embodiments comprising at least 0.01 wt-% (or at least 0.001 wt-%, or at least 0.0001 wt-%) of at least one base, based on the total weight of the composition.

Embodiment 37 is the composition of any one of the preceding embodiments comprising up to 5 wt-% (or up to 2.5 wt-%, or up to 1 wt-%) of at least one base, based on the total weight of the composition.

Embodiment 38 is the composition of any one of embodiments 1 to 37 in a one-part formulation.

Embodiment 39 is the composition of any one of embodiments 1 to 37 in a two-part formulation, wherein one part comprises the polyorganosiloxane and silane and one part comprises the base.

Embodiment 40 is the composition of any one of the preceding embodiments having a cure window of 1 minute to 30 minutes after application to a substrate.

Embodiment 41 is the composition of any one of the preceding embodiments having a VOC of no more than 750 grams per linter (g/L) (or no more than 500 g/L, or no more than 250 g/L).

Embodiment 42 is a curable composition comprising (or consisting essentially of): at least one polyorganosiloxane comprising at least one hydrosilyl moiety; at least one silane comprising hydrolyzable functionality; at least one base selected from an amidine, a guanidine, a phosphazene, a proazaphosphatrane, and a combination thereof; and at least one non-halogenated organic solvent having a boiling point of at least 160° C.

Embodiment 43 is a curable composition comprising (or consisting essentially of): at least two different polyorganosiloxanes, each comprising a different hydrosilyl equivalency; at least one silane comprising hydrolyzable functionality; at least one base selected from an amidine, a guanidine, a phosphazene, a proazaphosphatrane, and a combination thereof; and at least one non-halogenated organic solvent having a boiling point of at least 160° C.

Embodiment 44 is a coating method comprising: providing a curable composition of any one of the preceding embodiments; providing a substrate having a surface; applying the curable composition to at least a portion of the surface of the substrate; and allowing or inducing the curable composition to at least partially cure to form a coating.

Embodiment 45 is the method of embodiment 44 comprising allowing or inducing the curable composition to at least partially cure for at least 0.1 minute, or at least 1 minute.

Embodiment 46 is the method of embodiment 44 or 45 comprising allowing or inducing the curable composition to at least partially cure for up to 30 minutes.

Embodiment 47 is the method of any one of embodiments 44 to 46 further comprising removing uncured curable composition after at least partially curing the composition.

Embodiment 48 is the method of any one of embodiments 44 to 47, wherein the cured coating has an average thickness of at least 2.5 nm thick.

Embodiment 49 is the method of any one of embodiments 44 to 48, wherein the cured coating has an average thickness of up to 250 nm thick.

Embodiment 50 is a coating method comprising: providing is a curable composition comprising (or consisting essentially of): at least one polyorganosiloxane comprising at least one hydrosilyl moiety; and at least one base selected from an amidine, a guanidine, a phosphazene, a proazaphosphatrane, and a combination thereof; providing a substrate having a surface; applying the curable composition to at least a portion of the surface of the substrate; and allowing or inducing the curable composition to at least partially cure for at least 0.1 minute (or at least 1 minute) to form a coating; and removing uncured curable composition after at least partially curing the composition.

Embodiment 51 is the method of embodiment 50 comprising allowing or inducing the curable composition to at least partially cure for up to 30 minutes.

Embodiment 52 is an article comprising a substrate having a surface and an at least partially cured coating prepared by the coating method of any one of embodiments 44 to 51 disposed thereon.

Embodiment 53 is the article of embodiment 52, wherein the substrate surface comprises glass, plastic, metal, a painted surface, or a combination thereof.

Embodiment 54 is the article of embodiment 52 or 53 which is a vehicle or portion thereof.

Embodiment 55 is the article of any one of embodiments 52 to 54, wherein the coating is cured using the Coating Panel Preparation Method in the Examples Section, wherein a coating composition is applied twice and each time allowed to cure for 45 seconds before the excess coating solution is removed, with 30 minutes between coats, and the second coating allowed to further cure for 24 hours in a controlled temperature and humidity room set at 72° F. and 50% relative humidity.

Embodiment 56 is the article of embodiment 55, wherein the coating displays a Coefficient of Friction of less than 0.6 measured according to the Coefficient of Friction Test Method in the Examples Section.

Embodiment 57 is the article of embodiment 55 or 56, wherein the coating displays a receding contact angle of greater than 90 measured according to the Water Contact Angle Test Method of the Examples Section.

Embodiment 58 is the article of any one of embodiments 55 to 57, wherein the coating displays a receding contact angle of greater than 80 after 500 scrubs (made according to the Panel Scrub Test Method in the Examples Section) measured according to the Water Contact Angle Test Method in the Examples Section.

Embodiment 59 is the article of any one of embodiments 55 to 58, wherein the coating does not decrease the gloss of a substrate by more than 2% compared to the substrate without the coating disposed thereon, as measured using the Gloss Test Method in the Examples Section.

Embodiment 60 is the article of any one of embodiments 52 to 59, wherein the substrate is transparent.

Embodiment 61 is the article of embodiment 58, wherein the cured coating, prepared and cured using the Coating Panel Preparation Method in the Examples Section, has a haze of less than 0.5%, as measured using the Haze Test Method in the Example Section.

### EXAMPLES

Objects and advantages of this invention are further illustrated by the following examples, but the particular materials and amounts thereof recited in these examples, as well as other conditions and details, should not be construed to unduly limit this invention. These examples are merely for illustrative purposes only and are not meant to be limiting on the scope of the appended claims. Unless otherwise stated, all amounts are in weight percent.

Materials

| Abbreviation or | |
|---|---|
| Trade Name | Description |
| DBU | 1,8-Diazabicylco(5.4.0)undec-7-ene, “DBU” available from |
| | Evonik, Parsippany, NJ. |
| APS | 3-Aminopropyltrimethoxy silane, available under the trade |
| | designation “A-1110” from Momentive Performance Materials, |
| | Columbus, OH. |
| MAPS | 3-Methacryloxypropyl trimethoxysilane available, under the trade |
| | designation “Xiameter OFS 6030”, from Dow Chemical Company, |
| | Midland, MI. |
| MPS | 3-Mercaptopropyltrimethoxysilane available from Alfa Aesar, |
| | Haverhill, MA. |
| IOS | Isooctyltrimethoxysilane, available from Gelest, Morrisville, PA. |
| GPS | (3-Glycidoxypropyl)trimethoxysilane, available from Alfa Aesar, |
| | Haverhill, MA. |
| BSA | Bis[3-(trimethoxysiyl)propyl]amine available from TCI America, |
| | Portland, OR. |
| PDMS-50cst | Polydimethylsiloxane fluid available under the trade designation |
| | “Xiametr PMX-200 silicone fluid 50csf” from Dow Chemical |
| | Company, Midland, MI. |
| SYL-OFF 7678 | Dimethyl, methylhydrogen siloxane, trimethylsiloxy terminated |
| | available under the trade designation “SYL-OFF 7678” from Dow |
| | Chemical Company, Midland, MI. |
| MH-1109 | Cyclosiloxane, pentamethyl cyclopentasiloxane available under the |
| | trade designation “Dowsil MH-1109” from Dow Chemical |
| | Company, Midland, MI. |
| HMS-151 | Methylhydrosiloxane-dimethylsiloxane copolymer, |
| | trimethylsiloxane terminated available under the trade designation |
| | under the trade designation “HMS-151” from Gelest, Morrisville, |
| | PA. |
| Isopar L | Synthetic isoparaffinic hydrocarbon fluid available under the trade |
| | designation “ISOPAR L” from Exxon Mobil, Spring, Texas. |
| MEK | 2-Butanone (99%+) available from Alfa Aesar, Haverhill, MA. |
| OmniSolv Water | OmniSolv Water (PN 57156) available from MilliporeSigma, |
| | Burlington, MA. |

### Test Methods and Preparation Procedures

### Calculation of Mole Fraction Si—H

The hydrosilyl equivalency, reported as the mole fraction of Si—H, can be determined using ²⁹Si NMR and calculated as follows: collect quantitative silicon 29 NMR spectrum; reference NMR spectrum to D component (Me2SiO2/2) at roughly −20 ppm and DH component (MeHSiO_{2/2}) at roughly −35 ppm; integrate these two regions; calculate mol % DH found at −35 ppm by dividing the integrated value for the DH component by the total integrated value for the D+DH components; and report value as mol % DH.

### Test Panels

Painted Test Panels: 4 inches (in) (10.2 centimeters (cm))×12 in (30.5 cm)×0.32 in (0.81 cm), black painted test panels were obtained from ACT Test Panels LLC (Hillsdale, Mo.). Steel ID: C700 C59 IMM DIW ED6060c; Primer: 765224EH; Base Coat: 1370AB921 Black; Clear Coat: RK8211.

Glass Panels: float glass with a thickness of 0.1875 in (0.476 cm) was obtained from Cardinal Glass, Menomonie, Wis. and cut into approximately (˜) 4 in (10.2 cm)×6 in (15.2 cm)×0.1875 in (0.476 cm) panels.

### Panel Preparation

Painted Test Panels: Prior to coating, the act test panels were prepped with the following procedure: ˜1.0 g of Meguiar's M205 mirror glaze, available from Meguair's, Inc., Irvine, Calif., was spread evenly onto a Meguiar's Soft Buff DA Foam Polishing Disc, 6 in (15.2 cm), which was attached to a Meguiar's MT300 dual action polisher set to 5200 revolutions per minute (rpm). Using moderate pressure, each ACT test panel was polished for 1 minute. After polishing, the residue remaining on the panel was cleaned off using a 3M microfiber towel (PN 39016) available from 3M Company, St. Paul, Minn., and Foaming Aerosol Glass Cleaner (PN 08888) available from 3M Company.

Glass Panels: Prior to coating, the panels were cleaned using a 3M microfiber towel (PN 39016) available from 3M Company and Foaming Aerosol Glass Cleaner (PN 08888) available from 3M Company.

### Coating Panel Preparation Method

A prepped panel was coated using the following procedure: A 4 in (10.2 cm)×4 in (10.2 cm) cotton TX 304 TexWipe, available from Tex Wipe, Kernersville, N.C., was wrapped around a 1.5 in (3.8 cm)×3 in (7.6 cm) foam block available from Detailing.com (item # GYE-FOAMBLOCK). Approximately 0.5 milliliter (mL) of coating solution was applied to the cotton cloth wrapped foam block and then applied via wiping for 30 seconds onto panel. The coated panel was allowed to cure for 45 seconds before the excess coating solution was buffed off of the panel using a detailing cloth available under the trade designation “PERFECT-IT DETAILING CLOTH”, PN 06016, available from 3M Company. Each panel was coated twice with the coating solution waiting 30 minutes between coats. After the second coat was applied to the panel the panels were allowed to further cure for 24 hours in a controlled temperature and humidity room set at 72° F. and 50% relative humidity. After 24 hours, the panels were tested using the test methods described below.

### Water Contact Angle Test Method

The water contact angles were measured using a Rame-Hart goniometer available from Ramé-Hart Instrument Co., Succasunna, N.J. Advancing (θ_{adv}) and receding (θ_{rec}) angles were measured as fluid was supplied via a syringe into or out of sessile droplets (drop volume 2 μL). Static contact angle (θₛₜₐₜ) measurements were measured by raising the syringe needle height to a sufficient height so when a ˜6 microliter (μL) drop was dispensed from the needle, the drop would fall freely onto the panel surface and the free standing drop was measured. Measurements were taken at 3 different spots per sample and the reported measurements are the averages of the six values for each sample (a left-side and right-side measurement for each drop). The probe fluid used in this test was OmniSolv water. Contact Angle hysteresis (θ_{hys}) can be calculated using the following equation: θ_{hys}=θ_{adv}−θ_{rec}.

### Haze Test Method

Haze measurements were taken using a BYK Haze-Gard Plus available from BYK Gardner USA, Columbia, Md. Measurements were taken from at least 2 different locations and the data reported are the averages from these measurements.

### Gloss Test Method

Gloss measurements were taken using a BYK Trigloss available from BYK Gardner USA. Measurements were taken from at least 2 different locations and the data reported are the averages from these measurements.

### Coefficient of Friction (COF) Test Method

In a controlled temperature humidity room (72° F., 50% RH), a test panel was secured on top of a IMASS SP2000 available from IMASS, Accord, Massachusetts using the appropriate panel clips included with the IMASS. A friction sled with tether available from IMASS, Part # SP-101038, was modified by wrapping a pre-cut 2.5 in (6.4 cm)×8 in (20.3 cm) TX300 cotton wipe, available from from Tex Wipe, around the sled. A small slit was cut into the wipe to allow the tether to be exposed. The wipe was further secured with 233+ masking tape available from 3M Company. The modified friction sled was then attached to the IMASS SP2000 by the provided tether and the sled was placed onto the act test panel with the tape side up. The IMASS SP2000 settings were adjusted in the setup menu to the following: Sled Weight: 200 g; Initial Delay: 2 seconds; Averaging Time: 5 seconds; Units: In/Min; Testing Speed: 6 inches per minute (in/min). After the instrument was set up, samples were tested 3 times (15 seconds total) and the kinetic potential (KP) results were averaged.

### Panel Scrub Test Method

Panel scrub testing was performed by securing a panel into a BYK Gardner Scrub machine available from BYK Gardner USA. The scrub machine was equipped with the sponge holder attachment that was modified with an extra 500 grams (g) of weight. Total weight of the holder was ˜940 g.

Two 4.7 in (11.9 cm)×3.0 in (7.6 cm)×0.6 in (i.5 cm) sponge available under the trad designation “OCELO” from 3M Company, were cut to fit within the sponge holder. Approximately 500 mL of a prediluted (10:1 ratio with water) all-purpose cleaner, Meguair's D101 available from Meguiar's, Inc., was poured into the sample tray until the test panel was submerged in cleaner. The test panels were scrubbed using the scrub machine at a rate of 40 cycles/min for a total of 500 cycles. Contact angle measurements and gloss (for painted panels) or haze (for glass panels) were measured before and after scrubbing.

TABLE 1
List of materials and amounts used in Premix solutions.

| | Premix | | | | | | | | | |
|---|---|---|---|---|---|---|---|---|---|---|
| Catalyst | PM | PM | PM | PM | PM | PM | PM | PM | PM | PM |
| Premix | 1 | 2 | 3 | 4 | 5 | 6 | 7 | 8 | 9 | 10 |
| ISOPAR L | 2 | 2 | 2 | 2 | 2 | 2 | 3.5 | 4.5 | 2.5 | — |
| (g) | | | | | | | | | | |
| DBU (g) | 0.5 | 0.5 | 0.5 | 0.5 | 0.5 | 0.5 | 0.25 | 0.5 | — | 0.5 |
| APS (g) | 2.5 | — | — | — | — | — | 1.25 | — | 2.5 | 2.5 |
| MAPS (g) | — | 2.5 | — | — | — | — | — | — | — | — |
| BSA (g) | — | — | 2.5 | — | — | — | — | — | — | — |
| GPS (g) | — | — | — | 2.5 | — | — | — | — | — | — |
| IOS (g) | — | — | — | — | 2.5 | — | — | — | — | — |
| MPS (g) | — | — | — | — | — | 2.5 | — | — | — | — |
| MEK (g) | — | — | — | — | — | — | — | — | — | 2 |

### Example 1 (Ex. 1)

Premix 1 (PM 1): A catalyst pre-mix was prepared by adding ISOPAR L (2.0 g), APS (2.5 g) and DBU (0.5 g) to a glass vial. The vial was capped and inverted several times to mix the solution.

A coating composition was prepared by charging ISOPAR L (2.3 g), SYL-OFF 7678 (7.4 g), PDMS-50 cst (0.15 g), and Premix 1 (0.15 g) in a glass vial. The vial was capped and inverted several times to mix the solution. Once mixed, the solution was applied to a test panel as described above.

### Example 2-6 (Ex. 2-Ex. 6)

A similar procedure as used in Example 1 was used for making Examples 2-6 except that the Premix 1 was replaced with corresponding premix as listed in Table 1.

### Example 7 (Ex. 7)

A similar procedure as used in Example 1 was used for making Example 7 except that the SYL-OFF 7678 was replaced with HMS-151 and MEI 1109 and the Premix 1 was replaced with Premix 7 as listed in Table 1.

TABLE 2

| Component | Ex. 1 | Ex. 2 | Ex. 3 | Ex. 4 | Ex. 5 | Ex. 6 | Ex. 7 |
|---|---|---|---|---|---|---|---|
| ISOPAR L (g) | 2.3 | 2.3 | 2.3 | 2.3 | 2.3 | 2.3 | 2.3 |
| SYL-OFF 7678 (g) | 7.4 | 7.4 | 7.4 | 7.4 | 7.4 | 7.4 | — |
| MH-1109 (g) | — | — | — | — | — | — | 5.1 |
| HMS-151 (g) | — | — | — | — | — | — | 2.3 |
| DBU (g) | — | — | — | — | — | — | — |
| PDMS-50cst (g) | 0.15 | 0.15 | 0.15 | 0.15 | 0.15 | 0.15 | 0.15 |
| Premix (PM) | PM 1 | PM 2 | PM 3 | PM 4 | PM 5 | PM 6 | PM 7 |
| Amount (g) | 0.15 | 0.15 | 0.15 | 0.15 | 0.15 | 0.15 | 0.15 |
| Mol % DH | 70% | 70% | 70% | 70% | 70% | 70% | 51% |

TABLE 3

| Component | Ex. 1 | Ex. 2 | Ex. 3 | Ex. 4 | Ex. 5 | Ex. 6 | Ex. 7 |
|---|---|---|---|---|---|---|---|
| ISOPAR L (g) | 2.36 | 2.36 | 2.36 | 2.36 | 2.36 | 2.36 | 2.405 |
| SYL-OFF 7678 (g) | 7.4 | 7.4 | 7.4 | 7.4 | 7.4 | 7.4 | — |
| MH-1109 | — | — | — | — | — | — | 5.1 |
| HMS-151 | — | — | — | — | — | — | 2.3 |
| DBU (g) | 0.015 | 0.015 | 0.015 | 0.015 | 0.015 | 0.015 | 0.0075 |
| PDMS-50cst (g) | 0.15 | 0.15 | 0.15 | 0.15 | 0.15 | 0.15 | 0.15 |
| APS (g) | 0.075 | — | — | — | — | — | 0.0375 |
| MAPS (g) | — | 0.075 | — | — | — | — | — |
| BSA (g) | — | — | 0.075 | — | — | — | — |
| GPS (g) | — | — | — | 0.075 | — | — | — |
| IOS (g) | — | — | — | — | 0.075 | — | — |
| MPS (g) | — | — | — | — | — | 0.075 | — |
| Mol % DH | 70% | 70% | 70% | 70% | 70% | 70% | 51% |

TABLE 4

| Component | CE-1 | CE-2 | CE-3 | CE-4 | CE-5 |
|---|---|---|---|---|---|
| ISOPAR L (g) | 2.435 | 2.375 | 2.45 | — | — |
| SYL-OFF 7678 (g) | 7.4 | 7.4 | 7.4 | 7.4 | 9.76 |
| DBU (g) | 0.015 | — | — | 0.015 | 0.015 |
| PDMS-50cst (g) | 0.15 | 0.15 | 0.15 | 0.15 | 0.15 |
| APS (g) | — | 0.075 | — | 0.075 | 0.075 |
| MEK (g) | — | — | — | 2.36 | — |
| Mol % DH | 70% | 70% | 70% | 70% | 70% |

### Comparative Example 1 (CE-1)

Premix 8 (PM 8): A catalyst pre-mix was prepared by adding ISOPAR L (4.5 g) and DBU (0.5 g) to a glass vial. The vial was capped and inverted several times to mix the solution.

A coating composition was prepared by charging ISOPAR L (2.3 g), SYL-OFF 7678 (7.4 g), PDMS-50 cst (0.15 g), and Premix 8 (0.15 g) in a glass vial. The vial was capped and inverted several times to mix the solution. Once mixed, the solution was applied to a test panel as described above.

### Comparative Example 2 (CE-2)

Premix 9 (PM 9): A catalyst pre-mix was prepared by adding ISOPAR L (2.5 g) and APS (2.5 g) to a glass vial. The vial was capped and inverted several times to mix the solution.

A coating composition was prepared by charging ISOPAR L (2.3 g), SYL-OFF 7678 (7.4 g), PDMS-50 cst (0.15 g), and Premix 9 (0.15 g) in a glass vial. The vial was capped and inverted several times to mix the solution. Once mixed, the solution was applied to a test panel as described above.

### Comparative Example 3 (CE-3)

A coating composition was prepared by charging ISOPAR L (2.45 g), SYL-OFF 7678 (7.4 g), and PDMS-50 cst (0.15 g) in a glass vial. The vial was capped and inverted several times to mix the solution. Once mixed, the solution was applied to a test panel as described above.

### Comparative Example 4 (CE-4)

Premix 10 (PM 10): A catalyst pre-mix was prepared by adding MEK (2.5 g) DBU (0.5 g), and APS (2.5 g) to a glass vial. The vial was capped and inverted several times to mix the solution.

A coating composition was prepared by charging MEK (2.3 g), SYL-OFF 7678 (7.4 g), PDMS-50 cst (0.15 g), and Premix 10 (0.15 g) in a glass vial. The vial was capped and inverted several times to mix the solution. Once mixed, the solution was applied to a test panel as described above.

### Comparative Example (CE-5)

A coating composition was prepared by charging SYL-OFF 7678 (19.52 g), PDMS-50 cst (0.3 g), DBU (0.03 g), and APS (0.15 g) in a glass vial. The vial was capped and inverted several times to mix the solution. Once mixed, the solution was applied to a test panel as described above.

### Comparative Example 6 (CE-6)

Comparative example 6 was a non-coated panel as prepped in the procedure above.

TABLE 5

| | CE-1 | | CE-3 | | CE-5 | |
|---|---|---|---|---|---|---|
| | (no | CE-2 | (no | CE-4 | (no | |
| Component | siloxane) | (APS) | catalyst) | MEK | solvent) | CE-6 |
| ISOPAR L (g) | 2.3 | 2.3 | 2.45 | — | — | — |
| SYL-OFF 7678 (g) | 7.4 | 7.4 | 7.4 | 7.4 | 19.52 | — |
| DBU (g) | — | — | — | — | 0.03 | — |
| PDMS-50cst (g) | 0.15 | 0.15 | 0.15 | 0.15 | 0.3 | — |
| APS (g) | — | — | — | — | 0.15 | — |
| MEK (g) | — | — | — | 2.3 | | — |
| Premix (PM) | PM 8 | PM 9 | — | PM 10 | — | — |
| Amount (g) | 0.15 | 0.15 | | 0.15 | | |
| Mol % DH | 70% | 70% | 70% | 70% | 70% | — |

TABLE 6

| Glass: Examples | Ex. 1 | Ex. 2 | Ex. 3 | Ex. 4 | Ex. 5 | Ex. 6 |
|---|---|---|---|---|---|---|
| Advancing CA (°) | 106 | 106 | 106 | 109 | 107 | 104 |
| Initial | | | | | | |
| Advancing CA (°) | 99 | 29 | 48 | 28 | 38 | 69 |
| After Scrub | | | | | | |
| Receding CA (°) | 98 | 105 | 97 | 105 | 105 | 100 |
| Initial | | | | | | |
| Receding CA (°) | 86 | 16 | 23 | 19 | 23 | 46 |
| After Scrub | | | | | | |
| Static CA (°) | 105 | 106 | 104 | 106 | 106 | 103 |
| Initial | | | | | | |
| Static CA (°) | 93 | 26 | 49 | 28 | 36 | 70 |
| After Scrub | | | | | | |
| Haze Before | 0.16 | 0.19 | 0.16 | 0.17 | 0.17 | 0.11 |
| Coating (%) | | | | | | |
| Haze After Coating | 0.37 | 0.17 | 0.14 | 0.14 | 0.12 | 0.15 |
| (%) | | | | | | |

TABLE 7

| Glass: Comparative Examples | CE-1 | CE-2 | CE-3 | CE-4 | CE-5 | CE-6 |
|---|---|---|---|---|---|---|
| Advancing CA (°) Initial | 106 | 105 | 106 | — | — | 81 |
| Advancing CA (°) After | 34 | 97 | 34 | — | — | 62 |
| Scrub | | | | | | |
| Receding CA (°) Initial | 106 | 89 | 106 | — | — | 38 |
| Receding CA (°) After | 16 | 70 | 23 | — | — | 27 |
| Scrub | | | | | | |
| Static CA (°) Initial | 106 | 103 | 106 | — | — | 75 |
| Static CA (°) After Scrub | 34 | 86 | 34 | — | — | 59 |
| Haze Before Coating (%) | 0.16 | 0.09 | 0.16 | 0.14 | 0.17 | 0.19 |
| Haze After Coating (%) | 0.27 | 0.16 | 0.27 | 2.18 | 1.05 | 0.16 |

TABLE 8

| Paint: Examples | Ex. 1 | Ex. 2 | Ex. 3 | Ex. 4 | Ex. 5 | Ex. 6 | Ex. 7 |
|---|---|---|---|---|---|---|---|
| Advancing CA (°) | 105 | 106 | 105 | 105 | 106 | 106 | 106 |
| Initial | | | | | | | |
| Advancing CA (°) | 101 | 103 | 103 | 103 | 99 | 99 | 104 |
| After Scrub | | | | | | | |
| Receding CA (°) | 93 | 97 | 95 | 101 | 102 | 102 | 97 |
| Initial | | | | | | | |
| Receding CA (°) | 90 | 93 | 92 | 86 | 96 | 79 | 91 |
| After Scrub | | | | | | | |
| Static CA (°) | 101 | 105 | 104 | 106 | 104 | 104 | 103 |
| Initial | | | | | | | |
| Static CA (°) | 98 | 103 | 102 | 97 | 98 | 98 | 100 |
| After Scrub | | | | | | | |
| 20° Gloss Before | 88 | 88 | 87 | 88 | 88 | 88 | 87 |
| Coating (°) | | | | | | | |
| 20° Gloss After Coating | 88 | 87 | 86 | 87 | 87 | 87 | 86 |
| (°) | | | | | | | |
| COF Before Scrub | 0.23 | — | — | — | — | — | 0.23 |
| COF After Scrub | 0.35 | — | — | — | — | — | 0.58 |

TABLE 9

| Paint: Comparative Examples | CE-1 | CE-2 | CE-3 | CE-4 | CE-5 | CE-6 |
|---|---|---|---|---|---|---|
| Advancing CA (°) Initial | 106 | 106 | 95 | — | — | 78 |
| Advancing CA (°) After | 104 | 99 | 76 | — | — | 75 |
| Scrub | | | | | | |
| Receding CA (°) Initial | 96 | 85 | 59 | — | — | 47 |
| Receding CA (°) After | 82 | 68 | 37 | — | — | 36 |
| Scrub | | | | | | |
| Static CA (°) Initial | 106 | 99 | 93 | — | — | 74 |
| Static CA (°) After Scrub | 101 | 89 | 75 | — | — | 74 |
| 20° Gloss Before Coating (°) | 87 | 88 | 88 | 88 | 87 | 88 |
| 20° Gloss After Coating (°) | 88 | 88 | 88 | 81 | 58 | 88 |
| COF Before | 0.19 | — | 0.46 | — | 0.14 | 0.83 |
| COF After Scrub | 0.38 | — | 0.77 | — | 0.15 | 0.85 |

The complete disclosures of the patents, patent documents, and publications cited herein are incorporated by reference in their entirety as if each were individually incorporated. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. A curable composition comprising:
at least one polyorganosiloxane comprising at least one hydrosilyl moiety;
at least one silane comprising hydrolyzable functionality;
at least one base selected from an amidine, a guanidine, a phosphazene, a proazaphosphatrane, and a combination thereof; and
at least one non-halogenated organic solvent having a boiling point of at least 160° C.

2. (canceled)

3. The composition of claim 1, wherein the organic non-halogenated organic solvent is an aprotic solvent selected from isoparaffins, aromatic fluids, dearomatized fluids, non-dearomatized fluids, paraffins, glycol ethers or esters, esters, ketones, amides, cyclosiloxanes, monoterpenes, and combinations thereof.

4. The composition of claim 3 comprising at least 1 wt-% and
up to 99 wt-% of at least one non-halogenated organic solvent having a boiling point of at least 160° C., based on the total weight of the composition.

5. The composition of claim 1 wherein the polyorganosiloxane comprises a cyclic polymethyl(hydro)siloxane, an acyclic polymethyl(hydro)siloxane, a copolymer comprising methyl(hydro)siloxane units and dimethylsiloxane units, or a combination thereof.

6. The composition of claim 1 wherein the polyorganosiloxane comprises at least two hydrosilyl moieties.

7. The composition of claim 1 comprising at least two different polyorganosiloxanes, each comprising a different hydrosilyl equivalency.

8. The composition of claim 1, wherein the silane is a compound of the following Formula (IIIa):
R¹ₙ[Si(X)₄₋ₙ]ₘ
wherein:
m is 1 to 6;
n is 1 or 2; and
each R¹ is independently selected from an alkyl, alkylene, aryl, arylene, alkarylene, alkaryl, aralkylene, aralkyl, which may include a straight chain, branched, and/or cyclic group, having 1 to 18 carbon atoms, optionally containing one or more catenated heteroatoms selected from O, N, S, P, Si, and Cl, and optionally containing one or more functional groups selected from an amino, epoxy, thiol, (meth)acrylate, vinyl, allyl, isocyanate, thiocyanate, ureido, and chloro; and
each X is independently a hydrolyzable functional group selected from OR² (wherein R² is H or a (C1-C18)alkyl), or NR³R⁴ (wherein each R³ and R⁴ is independently H or a (C1-C18)alkyl or (C1-C18)alkylene).

9. The composition of claim 8, wherein m is 1 or 2, n is 1, and R¹ of Formula (IIIa) includes one or more functional groups selected from an amino, epoxy, thiol, (meth)acrylate, vinyl, allyl, isocyanate, thiocyanate, ureido, and chloro.

10. The composition of claim 1, wherein the base is selected from
an amidine compound represented by the following Formula (IV): 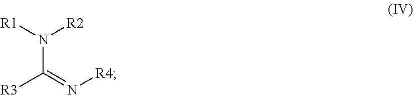
a guanidine compound represented by the following Formula (V): 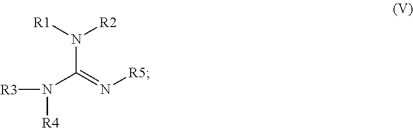
a phosphazene compound represented by the following Formula (VI): 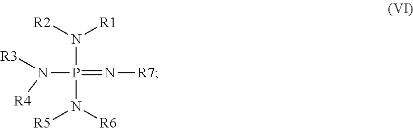
a proazaphosphatrane compound represented by the following Formula (VII): 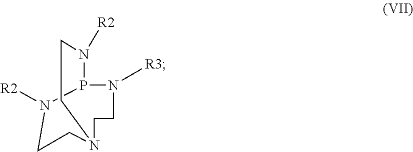
and a combination thereof;
wherein R1, R2, R3, R4, R5, R6, and R7 are each independently selected from hydrogen, monovalent organic groups, monovalent heteroorganic groups, and combinations thereof; and
wherein any two or more of R1, R2, R3, R4, R5, R6, and R7 of said amidine, guanidine, and/or phosphazene compounds optionally can be bonded together to form a ring structure.

11. The composition of claim 1 comprising at least 1 wt-% and up to 99 wt-% of at least one polyorganosiloxane comprising at least one hydrosilyl moiety, based on the total weight of the composition.

12. The composition of claim 1 comprising at least 0.1 wt-% and up to 10 wt-% of at least one silane comprising at least one hydrolyzable group, based on the total weight of the composition.

13. The composition of claim 1 comprising at least 0.01 wt-% and up to 5 wt-% of at least one base, based on the total weight of the composition.

14. A method comprising:
providing a curable composition of claim 1;
providing a substrate having a surface;
applying the curable composition to at least a portion of the surface of the substrate; and
allowing or inducing the curable composition to at least partially cure to form a coating.

15. An article comprising a substrate having a surface and an at least partially cured coating prepared by the coating method of claim 14 disposed thereon.
